(19) United States
(12) Patent Application Publication
(10) Pub. No.: US 2013/0195695 A1
(43) Pub. Date: Aug. 1, 2013

(54) HOLLOW ROTOR MOTOR AND SYSTEMS COMPRISING THE SAME

(71) Applicants: Jeremy Daniel Van Dam, West Coxsackie, NY (US); Manoj Ramprasad Shah, Latham, NY (US); Norman Arnold Turnquist, Carlisle, NY (US)

(72) Inventors: Jeremy Daniel Van Dam, West Coxsackie, NY (US); Manoj Ramprasad Shah, Latham, NY (US); Norman Arnold Turnquist, Carlisle, NY (US)

(73) Assignee: GENERAL ELECTRIC COMPANY, Schenectady, NY (US)

(21) Appl. No.: 13/408,202

(22) Filed: Feb. 29, 2012

Related U.S. Application Data
(60) Provisional application No. 61/592,191, filed on Jan. 30, 2012.

(51) Int. Cl. F04B 17/00; H02K 9/00

(52) U.S. Cl. 417/410.1; 310/54

(57) ABSTRACT

In one or more embodiments, the present invention provides electric motors and related systems comprising (a) a motor housing; and (b) a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel.

This application claims priority from U.S. Provisional Application having Ser. No. 61/592,191 filed Jan. 30, 2012 and which is incorporated herein by reference in its entirety.

### STATEMENT REGARDING FEDERALLY SPONSORED RESEARCH & DEVELOPMENT

One or more aspects of the invention described herein were developed under Cooperative Agreement DE-EE0002752 for the U.S. Department of Energy entitled “High-Temperature-High-Volume Lifting for Enhanced Geothermal Systems.” As such, the government has certain rights in this invention.

### BACKGROUND

In one aspect, the present invention provides advanced motor technology which is particularly useful for well fluids lifting systems. A major challenge is to provide well fluids lifting systems which can withstand the extreme pressure and temperature of thermal energy recovery wells while providing sufficient longevity to meet the needs of the Enhanced Geothermal Systems (EGS) industry for the coming years. At present, there are few, if any, viable well fluids lifting systems capable of prolonged operation within the types of geothermal wells needed to provide significant amounts of geothermal energy for human use.

### BRIEF DESCRIPTION

In one embodiment, the present invention provides an electric motor comprising a motor housing; and a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel.

In another embodiment, the present invention provides an electric fluid pump comprising: (a) an electric motor comprising: (i) a motor housing; and (ii) a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel; (b) a transition section configured to join the hollow rotor to a drive shaft of a pumping device to be powered by the motor; (c) one or more intake ports defined by the transition coupling, the first end portion, or both the transition coupling and the first end portion; said intake ports being in fluid communication with the flow channel of the hollow rotor; and (d) a pumping device comprising a fluid inlet and one or more impellers fixed to a drive shaft powered by the electric motor.

In yet another embodiment, the present invention provides a machine for electric power generation comprising: (a) a generator comprising: (i) a generator housing; and (ii) a hollow magnetic rotor configured to rotate within a stator contained within the generator housing; wherein the generator housing is characterized by a largest cross-sectional area of the generator housing, and wherein the hollow magnetic rotor defines a flow channel characterized by a smallest cross-sectional area of the flow channel, wherein the smallest cross-sectional area of the flow channel is at least 25% of the largest cross-sectional area of the generator housing, and wherein the hollow magnetic rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel; (b) a transition section configured to join the hollow magnetic rotor to a drive shaft of a turbine device configured to drive the hollow magnetic rotor; and (c) one or more intake ports defined by the transition coupling, the first end portion, or both the transition coupling and the first end portion; said intake ports being in fluid communication with the flow channel of the hollow magnetic rotor; wherein the turbine device comprises one or more impellers fixed to the drive shaft.

In yet another embodiment, the present invention provides an electric fluid pump which is an Electric Submersible Pump (ESP) optimized for operation within a well bore.

### BRIEF DESCRIPTION OF DRAWING FIGURES

These and other features, aspects, and advantages of the present invention will become better understood when the following detailed description is read with reference to the accompanying drawings in which like characters represent like parts throughout the drawings, wherein:

FIG. 1 illustrates one or more embodiments of the present invention;

FIG. 2 illustrates one or more embodiments of the present invention;

FIG. 3 illustrates one or more embodiments of the present invention;

FIG. 4 illustrates one or more embodiments of the present invention;

FIG. 5 illustrates one or more embodiments of the present invention;

FIG. 6 illustrates one or more embodiments of the present invention;

FIG. 7 illustrates one or more embodiments of the present invention;

FIG. 8 illustrates one or more embodiments of the present invention;

FIG. 9 illustrates one or more embodiments of the present invention;

FIG. 10 illustrates one or more embodiments of the present invention;

FIG. 11 illustrates one or more embodiments of the present invention; and

FIG. 12 illustrates one or more embodiments of the present invention.

### DETAILED DESCRIPTION

As noted, in one embodiment, the present invention provides an electric motor comprising a motor housing; and a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel.

A variety of motor topologies may be used, including Surface Mounted Permanent Magnet, Internal Permanent Magnet, Induction, Wound Field, Synchronous Reluctance, and Switched Reluctance topologies. In one or more embodiments the motor is of the Surface Mounted Permanent Magnet type.

In one or more embodiments the electric motor provided by the present invention, is characterized by a smallest cross-sectional area of the flow channel of from 25% to about 75% of the largest cross-sectional area of the motor housing.

In one or more embodiments the electric motor provided by the present invention, is characterized by a smallest cross-sectional area of the flow channel of from 30% to about 55% of the largest cross-sectional area of the motor housing.

In one or more embodiments the electric motor provided by the present invention further comprises a transition section (at times herein referred to as a transition coupling) configured to join the hollow rotor to a drive shaft of a device to be powered by the motor; and one or more intake ports defined by the transition coupling, the first end portion, or both the transition coupling and the first end portion; said intake ports being in fluid communication with the flow channel of the hollow rotor. In one or more embodiments the transition section is a coupling which may be integral to or separate from either the hollow rotor or the drive shaft of the device.

In one or more embodiments the transition coupling defines one or more intake ports. In another embodiment, the first end portion defines one or more intake ports. In yet another embodiment, both the transition coupling and the first end portion each define at least one intake port. In yet another embodiment, only the transition coupling defines one or more intake ports.

In one or more embodiments, the electric motor further comprises a dielectric fluid, at times herein referred to as a dielectric coolant fluid. In one or more embodiments, a dielectric fluid filled gap separates an outer surface of the hollow rotor from the stator. Suitable dielectric coolant fluids include silicone oils, aromatic hydrocarbons such as biphenyl, diphenylether, fluorinated polyethers, silicate ester fluids, perfluorocarbons, alkanes, and polyalphaolefins.

In another embodiment, a gas fluid filled gap separates an outer surface of the hollow rotor from the stator. In one embodiment, the gas within the gap may be air. In another embodiment, the gas within the gap may be a relatively inert gas such as helium or argon. In one embodiment, the gas within the gap is nitrogen.

In one or more embodiments, the motor provided by the present invention comprises an encapsulated stator such as those described in U.S. Pat. No. 7,847,454, U.S. Divisional application Ser. No. 12/904,523, and U.S. patent application Ser. Nos. 12/915,604 and 12/940,524 which are incorporated by reference in their entirety.

As noted, in one or more embodiments the present invention provides an electric fluid pump comprising: (a) an electric motor comprising: (i) a motor housing; and (ii) a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel; (b) a transition section configured to join the hollow rotor to a drive shaft of a pumping device to be powered by the motor; (c) one or more intake ports defined by the transition coupling, the first end portion, or both the transition coupling and the first end portion; said intake ports being in fluid communication with the flow channel of the hollow rotor; and (d) a pumping device comprising a fluid inlet and one or more impellers fixed to a drive shaft powered by the electric motor.

In one or more embodiments, the electric fluid pump provided by the present invention comprises a first set of impellers mounted on a first drive shaft, and a second set of impellers mounted on a second driveshaft, said first and second drive shafts being configured to be driven by the hollow rotor, said first and second drive shafts being configured to rotate in opposite directions.

In one or more embodiments, the electric fluid pump provided by the present invention comprises a pumping device housing (also referred to as a pump housing) defining a fluid inlet and containing a pump section comprising one or more impellers fixed to a drive shaft powered by the electric motor. In one or more embodiments, the electric fluid pump comprises stationary diffusers mounted to an inner surface of the pumping device housing.

In yet another embodiment, the present invention provides a machine for electric power generation comprising: (a) a generator comprising: (i) a generator housing; and (ii) a hollow magnetic rotor configured to rotate within a stator contained within the generator housing; wherein the generator housing is characterized by a largest cross-sectional area of the generator housing, and wherein the hollow magnetic rotor defines a flow channel characterized by a smallest cross-sectional area of the flow channel, wherein the smallest cross-sectional area of the flow channel is at least 25% of the largest cross-sectional area of the generator housing, and wherein the hollow magnetic rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel; (b) a transition section configured to join the hollow magnetic rotor to a drive shaft of a turbine device configured to drive the hollow magnetic rotor; and (c) one or more outlet ports defined by the transition coupling, the first end portion, or both the transition coupling and the first end portion; said intake ports being in fluid communication with the flow channel of the hollow magnetic rotor; wherein the turbine device comprises one or more impellers fixed to the drive shaft.

In one or more embodiments, the machine for electric power generation provided by the present invention further comprises a turbine device housing defining one or more fluid outlets. In one or more embodiments, the machine for electric power generation provided by the present invention further comprises a turbine device housing defining one or more fluid inlets.

In one or more embodiments, the machine for electric power generation provided by the present invention further comprises a pressurized dielectric fluid in a gap separating the outer surface of the hollow rotor from the stator.

In one or more embodiments, the machine for electric power generation provided by the present invention comprises an encapsulated stator.

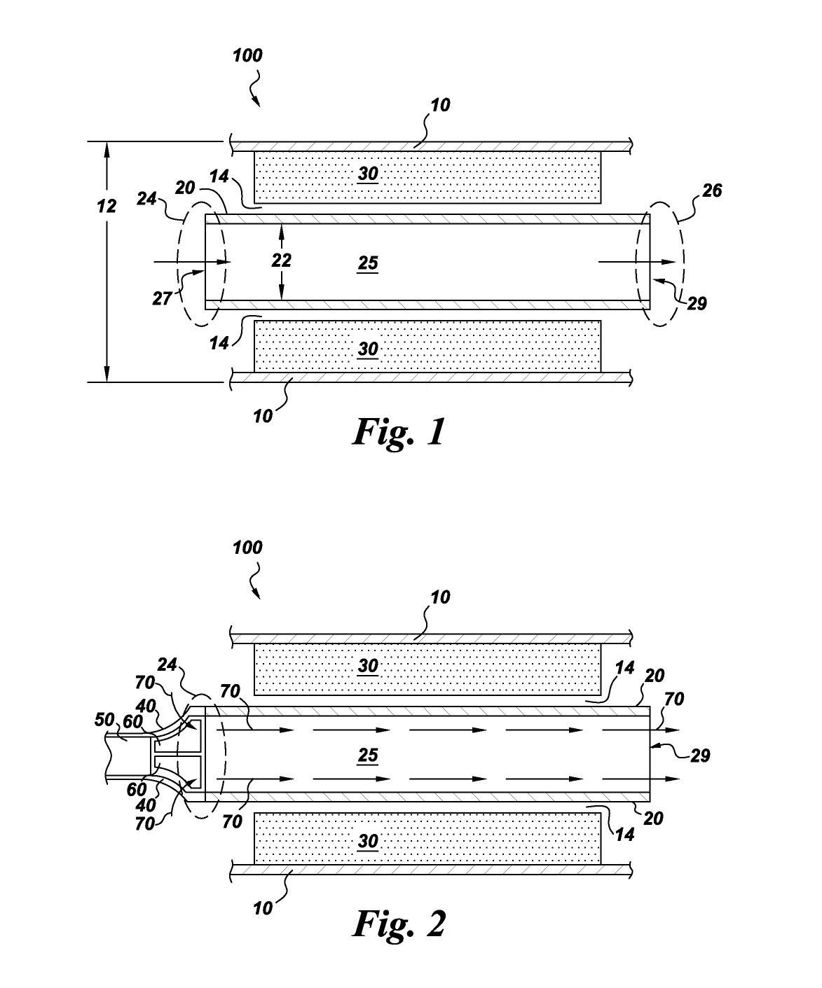

Referring now to the figures, FIG. 1 illustrates a large diameter electric motor 100 provided by the present invention, the motor comprising a motor housing 10 and a hollow rotor 20 disposed within the motor. Hollow rotor 20 is configured to rotate within and be driven by stator 30 which is contained within the motor housing. A gap 14 separates the outer surface of the hollow rotor from the stator. Gap 14 is at times herein referred to as an air gap, but may in one or more embodiments be filled with a dielectric coolant fluid, air or another fluid. Hollow rotor 20 defines a flow channel 25 characterized by a smallest cross-sectional area 22. Similarly, motor housing 10 is characterized by a largest cross-sectional area 12. In one or more embodiments both the flow channel 25 and motor housing 10 are cylindrical in shape, and are characterized by a single flow channel cross-sectional area and a single motor housing cross-sectional area. Under such circumstances, the cross-sectional area of flow channel 25 is at least 25% of the cross-sectional area of motor housing 10. In the embodiment shown, hollow rotor 20 has a first end portion 24 defining a fluid inlet 27. Hollow rotor 20 further defines a second end portion 26 defining fluid outlet 29. The fluid inlet 27, the flow channel 25 and the fluid outlet 29 are in fluid communication such that a fluid, for example a liquid, entering the hollow rotor via the fluid inlet may pass through the flow channel and exit the fluid outlet.

Referring now to FIG. 2, the figure illustrates a large diameter electric motor 100 provided by the present invention, the motor comprising a transition coupling 40 (at times herein referred to as a transition section) configured to join the hollow rotor 20 to a drive shaft 50 of a device (not shown) to be powered by the motor. In the embodiment shown, intake ports 60 allow a fluid to pass into flow channel 25 as suggested by flow direction arrows 70. In one or more embodiments the transition coupling 40 is separate from the hollow rotor and the drive shaft 50 and couples to each, for example by friction joints, shrink fittings, threading, or a combination thereof. In one or more embodiments, the transition coupling is integral to the hollow rotor and couples to drive shaft 50. In one or more embodiments, the transition coupling is integral to the drive shaft of the device to be powered by the motor and couples to the hollow rotor. In one or more embodiments the intake ports 60 are characterized by one or more cross sectional areas, and a sum of these cross sectional areas of the intake ports is substantially equal to, or larger than, the smallest cross-sectional area of the flow channel 25.

Referring now to FIG. 3, the figure illustrates a large diameter electric motor 100 provided by the present invention. In the embodiment shown, the motor is coupled to drive shaft 50 of a pump configured to pump a fluid into and through flow channel 25. In one or more embodiments, a fluid may be impelled by a series of impellers (not shown) axially along drive shaft 50 toward and though intake ports 60. Seals 80 prevent this working fluid from entering the motor and coming into contact with internal motor components such as the stator. In one or more embodiments, the motor is filled with a pressurized dielectric fluid which is at a higher pressure than the environment outside of the motor. In one or more embodiments the pressurized dielectric fluid leaks outwardly from the motor interior as a means of preventing ingress of the working fluid into the interior of the motor. Seals 80 are typically of the face seal type. In one or more embodiments, seal 80 comprises a stationary seal component fixed within the motor housing and a moving seal component attached to the hollow rotor, the stationary seal component and moving seal component defining a leakage pathway through which a pressurized dielectric fluid may flow. In the embodiment shown, transition coupling 40 is shown as integral to drive shaft 50 and as defining intake ports 60. In the embodiment shown, transition coupling 40 defines intake ports 60, and the first end portion (FIG. 1) of the hollow rotor lacks intake ports.

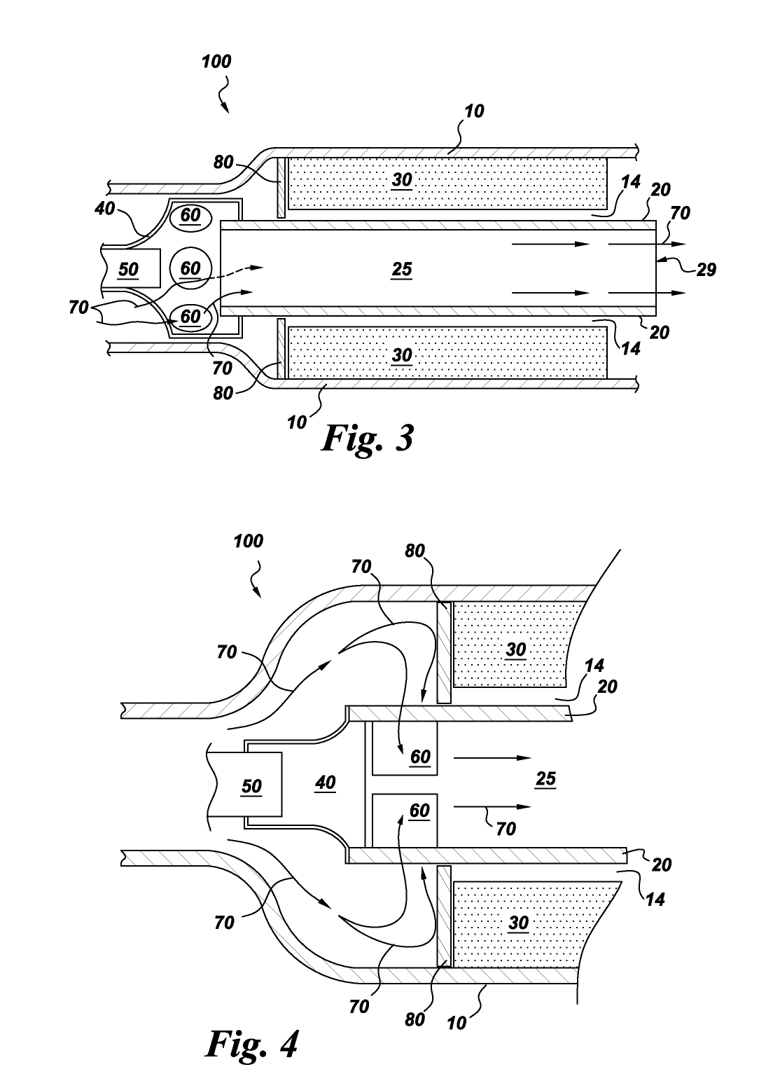

Referring now to FIG. 4, the figure illustrates a large diameter electric motor 100 provided by the present invention. In the embodiment shown, transition coupling 40 is shown as integral to hollow rotor 20. It should be noted that transition coupling 40, in this or any other embodiment, is not considered when determining the smallest cross-sectional area of the flow channel. In the embodiment shown, the motor is configured to power drive shaft 50 of a pump section (not shown) which acts upon and moves a working fluid (not shown) axially along drive shaft 50 as indicated by direction arrows 70. The working fluid enters flow channel 25 via intake ports 60. In the embodiment shown, the first end portion (FIG. 1) of the hollow rotor 20 defines intake ports 60 and transition coupling 40 lacks intake ports.

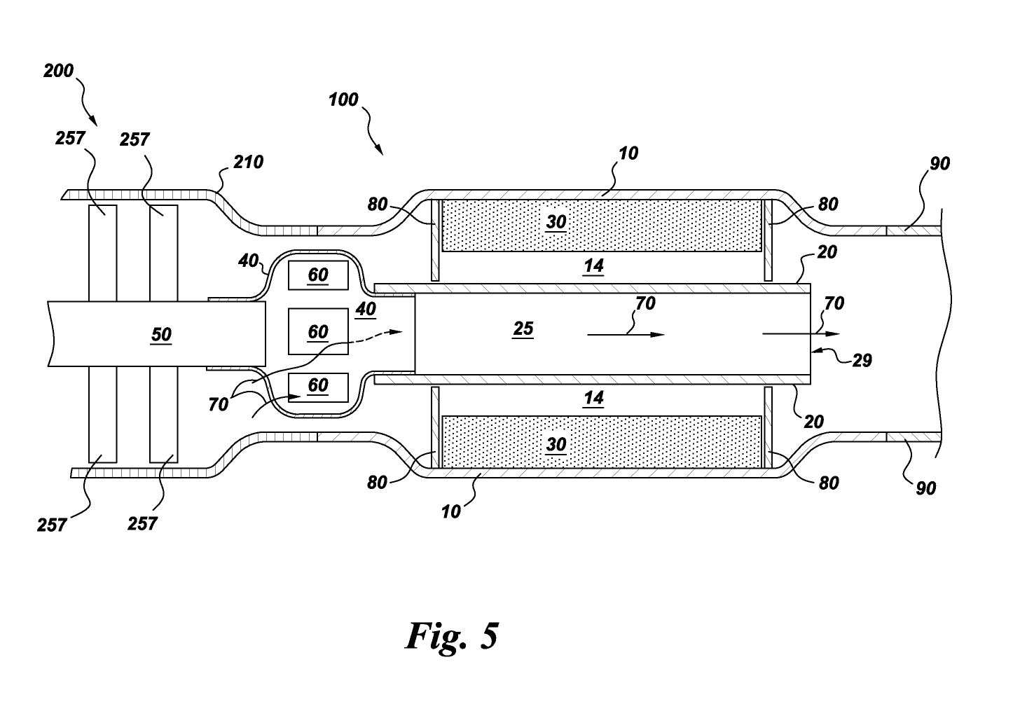

Referring now to FIG. 5, the figure illustrates an electric fluid pump according to one or more embodiments of the present invention. The electric fluid pump comprises a large diameter electric motor 100 configured to power a pump 200. In the embodiment shown, only a portion of pump 200 is visible. Pump 200 comprises a pump housing 210 and impellers 257 attached to drive shaft 50 which is coupled to hollow rotor 20 of large diameter electric motor 100 via transition coupling 40. In the embodiment shown, transition coupling 40 is an independent component (i.e. not integral to either of drive shaft 50 or hollow rotor 20) joining to both drive shaft 50 and hollow rotor 20. Transition coupling 40 defines intake ports 60, and no intake ports are defined by hollow rotor 20. Electric motor 100 comprises motor housing 10 which, in the embodiment shown, is joined to pump housing 210 on the fluid inlet end of the hollow rotor and is joined to conduit 90 on the outlet end of the hollow rotor. In one or more embodiments, conduit 90 is configured to receive fluid impelled by pump 200 through flow channel 25 of hollow rotor 20 as indicated by fluid direction arrows 70.

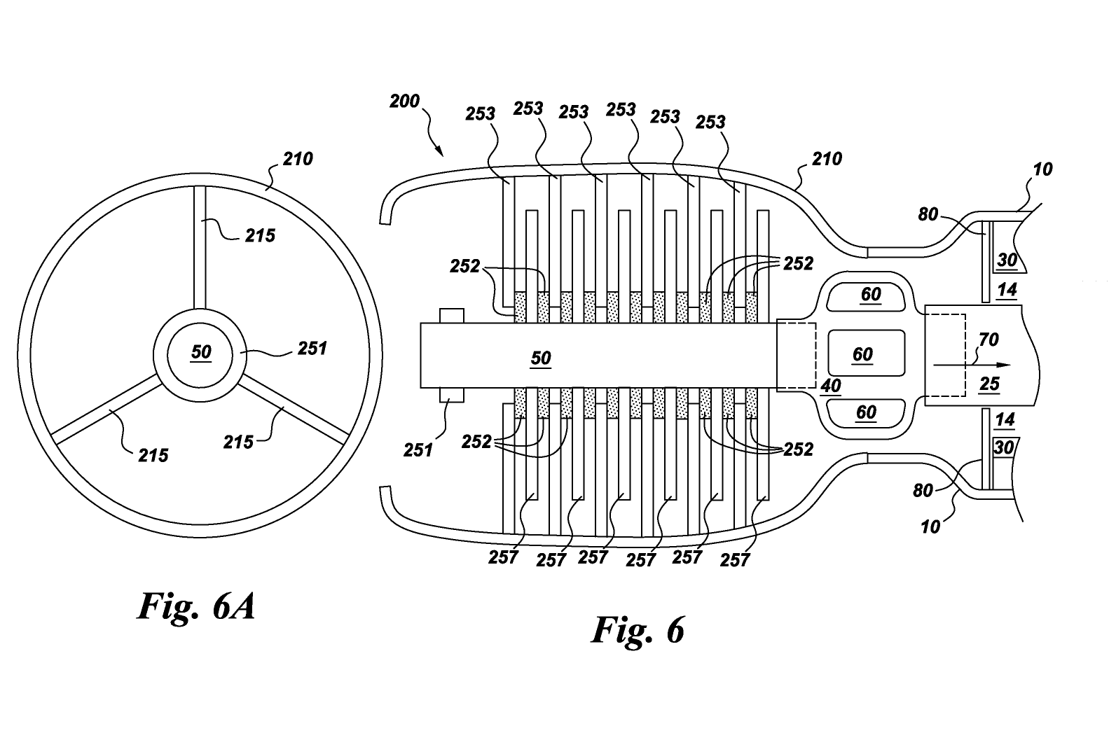

Referring now to FIG. 6, the figure illustrates an electric fluid pump according to one or more embodiments of the present invention. The electric fluid pump comprises a large diameter electric motor 100 configured to power a pump 200. In the embodiment shown, only a portion of motor 100 is visible. Pump 200 comprises a pump housing 210 and impellers 257 attached to drive shaft 50 which is coupled to hollow rotor 20 of large diameter electric motor 100 via transition coupling 40. In the embodiment shown, transition coupling 40 is an independent component (i.e. not integral to either of drive shaft 50 or hollow rotor 20) joining to both drive shaft 50 and hollow rotor 20. Pump 200 also comprises stationary diffusers 253 and thrust bearings 252. Thrust bearings 252, at times herein referred to as thrust washers, are positioned between the stationary diffusers and the rotatory impellers. In the embodiment shown, drive shaft 50 is shown as supported by radial bearing 251 which is shown in an enlarged end-on view in FIG. 6a in which radial bearing 251 is supported by support struts 215. Although only a single radial support bearing is featured in FIG. 6, a plurality of radial bearings is typically included in the large diameter electric motors, electric fluid pumps, and machines for electric power generation provided by the present invention.

Referring now to FIG. 7, the figure illustrates a transition coupling 40 according to one or more embodiments of the present invention. In the embodiment shown, the transition coupling is a single independent component configured to be joined via first coupling 41 to a drive shaft (50) and configured to be joined via a second coupling 42 to a hollow rotor (20). The transition coupling defines a plurality of intake ports 60. In the embodiment shown, transition coupling 40 may join to each of drive shaft 50 and hollow rotor 20 via, for example, friction joints, shrink fit joints, or a combination thereof.

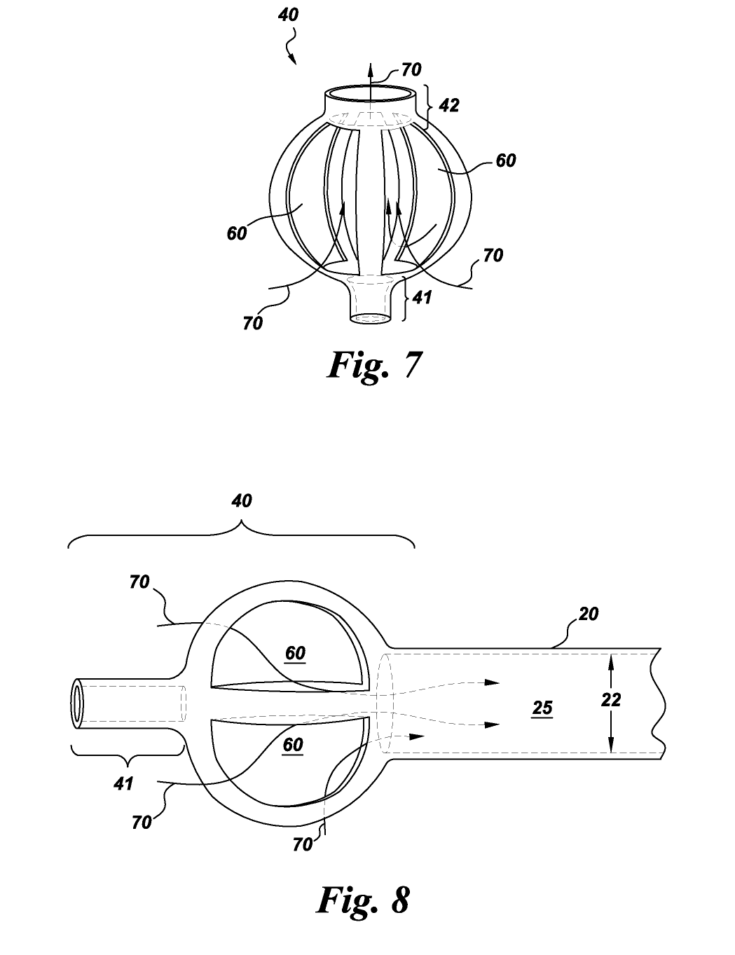

Referring now to FIG. 8, the figure illustrates a transition section 40 which is integral to and forms part of a hollow rotor 20 according to one or more embodiments of the present invention. Transition section 40 includes a first coupling configured to join to drive shaft of a device configured to be driven by hollow rotor 20. While both first coupling 41 and intake ports 60 are integral to and form a part of hollow rotor 20, the transition section 40 is not considered in calculation of the smallest cross-sectional area 22 of flow channel 25.

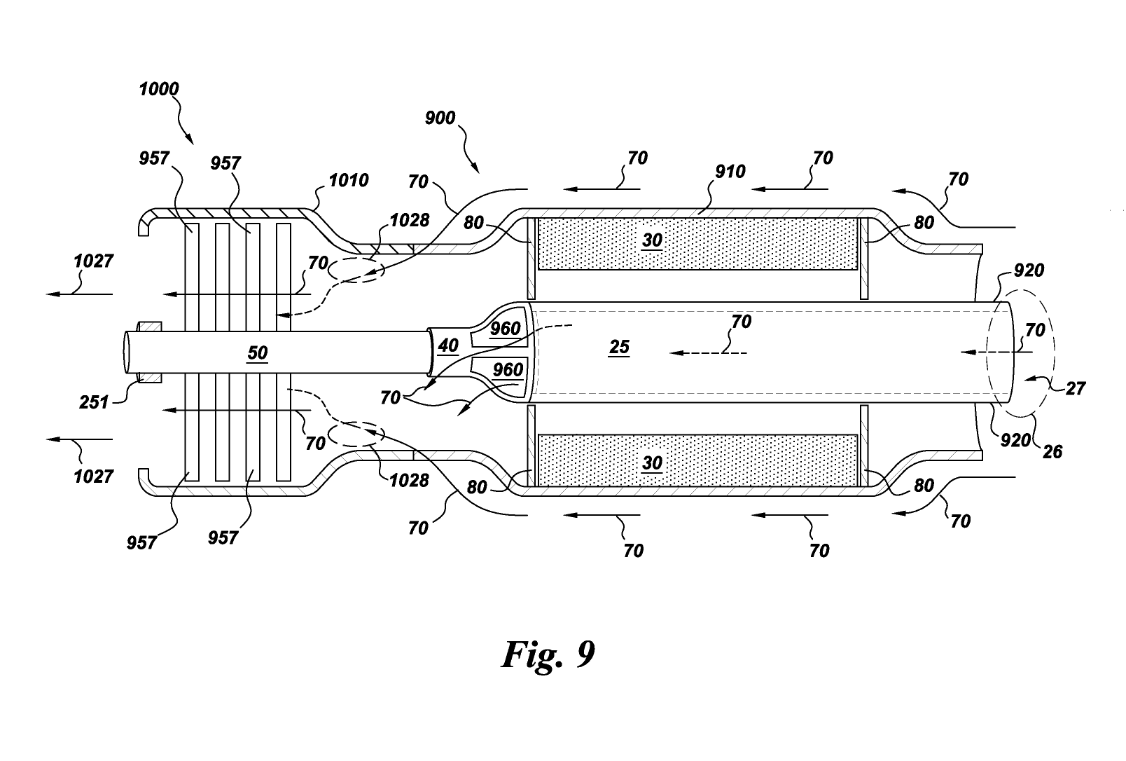

Referring now to FIG. 9, the figure illustrates a machine for electric power generation according to one or more embodiments of the present invention. In the embodiment shown, the machine comprises a generator 900 comprising a generator housing 910 and a hollow magnetic rotor 920 configured to rotate within a stator 30 contained within the generator housing. The generator housing 910 is characterized by a largest cross-sectional area. The hollow magnetic rotor defines a flow channel 25 running the length of the hollow magnetic rotor and being characterized by a smallest cross-sectional area, the smallest cross-sectional area of the flow channel being at least 25% of the largest cross-sectional area of the generator housing. The hollow magnetic rotor has a first end portion 24 defining a fluid outlet 29, and a second end portion 26 defining a fluid inlet 27. The fluid inlet, the flow channel and the fluid outlet are in fluid communication such that a fluid entering the flow channel 25 via the fluid inlet 27 may pass through flow channel 25 and exit the hollow magnetic rotor via fluid outlet 29. The fluid inlet, the flow channel and the fluid outlet may be said to be configured to allow passage of a fluid from the fluid inlet to the fluid outlet via the flow channel. The machine for electric power generation comprises a transition section 40 configured to join the hollow magnetic rotor to a drive shaft of a turbine device configured to drive the hollow magnetic rotor. In the embodiment shown, transition section 40 is shown as defining outlet ports 960 configured to allow passage of fluid from the flow channel and fluid outlet of the hollow magnetic rotor. Transition section 40 is coupled to drive shaft 50 of turbine 1000 (at times herein referred to as a turbine device). In the embodiment shown, turbine 1000 comprises turbine blades 957 and turbine housing 1010.

In one or more embodiments, during operation, the machine for electric power generation illustrated in FIG. 9 generates electricity as follows. A fluid flowing under pressure enters hollow magnetic rotor hollow via fluid inlet 27 and flows through flow channel 25 as indicated by direction arrows 70. Fluid passes into the transition section and exits into the cavity defined by generator housing 910 and turbine housing 1010. The fluid flowing under pressure encounters and turbine blades 957 during its passage through the turbine. Energy from the fluid is transferred to the turbine blades causing the blades and drive shaft 50 to rotate. The rotation of drive shaft 50, in turn, causes the hollow magnetic rotor 920 to rotate in close proximity to stator 30 and generating electric power thereby. The fluid, having transferred a portion of its contained energy to the turbine then passes out of turbine 1000 via turbine fluid outlet 1027.

In one or more embodiments, the turbine housing defines one or more fluid inlets 1028. These may be useful when the machine for electric power generation is operated in a confined space such as a pipe or a well bore or other conduit wherein a portion of the fluid flowing under pressure is allowed to flow along the outer surface of generator housing 910. For example a fluid flowing under pressure may encounter the fluid inlet 27 end of the machine for electric power generation disposed within a conduit such that a gap exists between the outer surface of the generator housing and the inner wall of the conduit. A first portion of the fluid flowing under pressure passes into flow channel 25 while a second portion of the fluid passes along the outer surface of the generator housing. The second portion then encounters the outer surface of the turbine housing which defines fluid inlets 1028. Some or all of the second portion of the fluid enters the turbine and contacts the turbine blades and a portion of the energy contained in the second portion of the fluid is transferred to the turbine. In one or more embodiments, the turbine housing is configured to partially or completely occlude fluid passage between the outer surface of the turbine housing and the inner wall of the conduit.

Those of ordinary skill in the art will appreciate the close relationship between one or more embodiments of the machine for electric power generation provided by the present invention and one or more embodiments of the electric fluid pump provided by the present invention. Thus, simply reversing the direction of fluid flow and electric current flow may convert a power consuming electric fluid pump into an electric power generating machine. In the context of a geothermal production well, for example, an electric fluid pump provided by the present invention and disposed within a geothermal production well may pump hot water from a geothermal field to a thermal energy extraction facility at the surface.

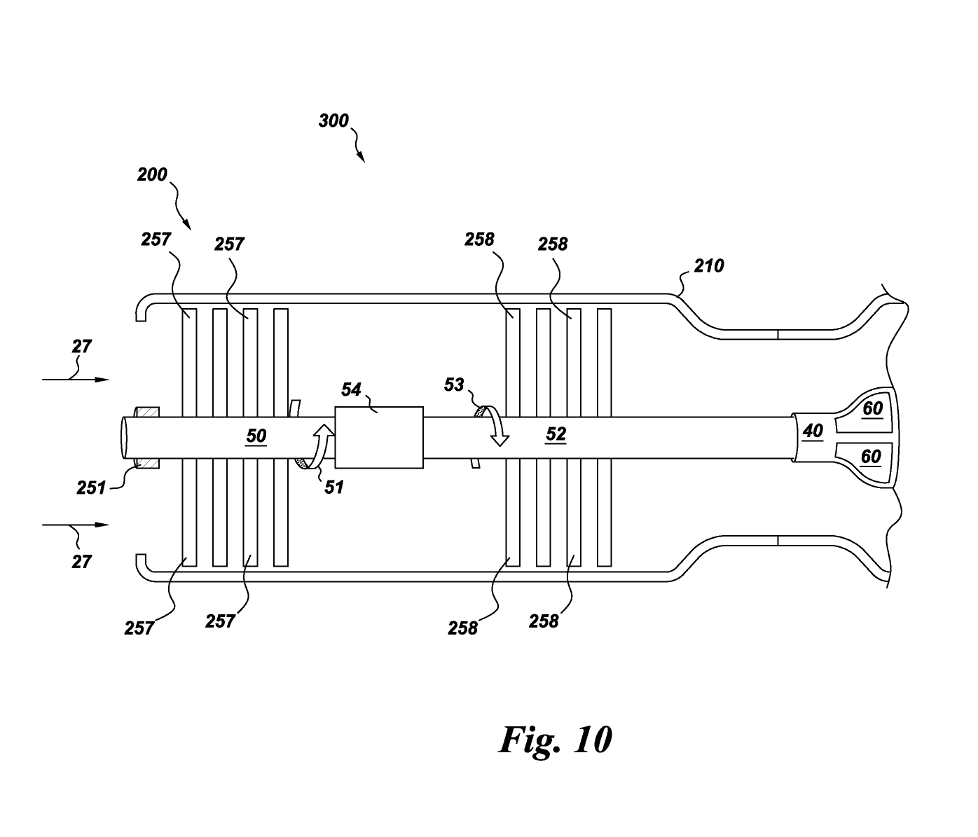

Referring now to FIG. 10, the figure illustrates an electric fluid pump 300 according to one or more embodiments of the present invention. The pump comprises a hollow rotor electric motor (not shown) provided by the present invention and pumping section 200 comprising a first set of impellers 257 mounted on a first drive shaft 50 configured to rotate in direction 51, and a second set of impellers 258 mounted on a second driveshaft 52 configured to rotate in direction 53, said first and second drive shafts being configured to be driven by the hollow rotor, said first and second drive shafts being configured to rotate in opposite directions via planetary gear box 54.

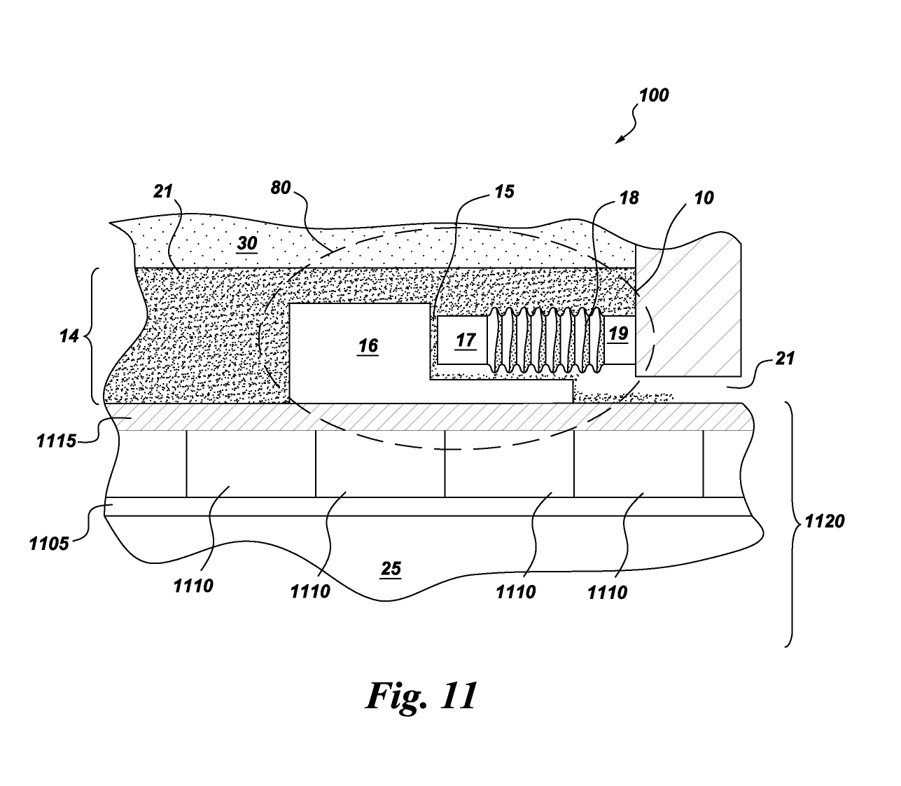

Referring now to FIG. 11, the figure illustrates a seal 80 within a hollow rotor electric motor according to one or more embodiments of the present invention. The figure shows a portion of a hollow magnetic rotor 1120 having a rotor shaft 1105 defining a flow channel 25. Permanent magnets 1110 are attached to the outer surface of the rotor shaft 1105 by magnet retaining ring 1115. In the embodiment shown, the motor contains a pressurized dielectric fluid 21 in contact with stator 30 and filling the gap 14 between the outer surface of the hollow rotor magnetic rotor 1120 and stator 30. Seal 80 prevents ingress of working fluid (not shown) into the internal parts of the motor 100. Seal 80 comprises a rotating portion 16 fixed to the outer surface of and rotates with hollow rotor magnetic rotor 1120. Seal 80 also comprises a stationary portion comprised of fixed seal portion 17, seal bellows 18 and seal mount 19 attached to a non-moving surface of the motor, in the embodiment shown to the motor housing. Seal 80 defines a seal leakage path 15 through which a small amount of the pressurized dielectric fluid 21 may flow thereby preventing ingress of the working fluid into the internal parts of the motor.

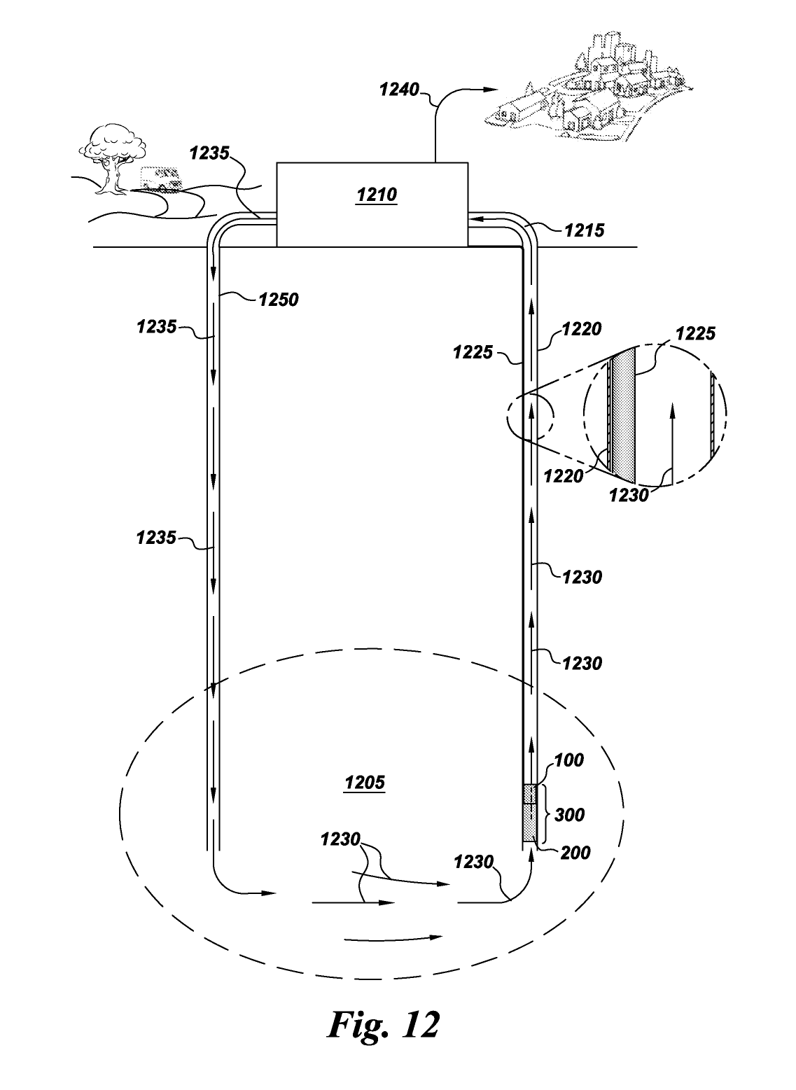

Referring now to FIG. 12, the figure illustrates a geothermal well and thermal energy extraction system 1200 according to one or more embodiments of the present invention. In the embodiment shown, an electric fluid pump 300 provided by the present invention and comprising hollow rotor electric motor 100 and pump section 200 is disposed within a geothermal production well 1220. Production well 1220 is supplied with hot water 1230 from geothermal field 1205. In one embodiment, hot water 1230 is at a temperature of 300° C. and a pressure of 300 bar. Hot water from geothermal field 1205 enters geothermal production well 1220 and is impelled to the surface by electric fluid pump 300 powered by electric cable 1225. At the surface, energy 1240 is extracted from the hot water in an energy recovery unit 1210 coupled to production well 1220 at wellhead 1215. As will be appreciated by those of ordinary skill in the art, various methods may be employed including producing steam and driving an electric turbine. In one embodiment, the energy recovery unit comprises an organic Rankine cycle. Cooled water 1235 produced by removing energy from hot water 1230 is returned to geothermal field 1205 via injection well 1250 where it absorbs heat from the field to produce hot water 1230.

As noted, in one embodiment, the present invention provides an electric motor comprising a motor housing; and a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel.

Such motors are useful for a wide variety of applications. For example, the motors provided by the present invention may be used in situations in which, during operation, the motor is disposed within a confined space such as a pipe, a shipboard compartment or a well bore. In one embodiment, the present invention provides a motor useful in an in-line pump capable of moving a fluid at relatively high rates as compared to conventional in-line pumps. It is believed that the motors provided by the present invention and the pumping systems comprising them will be useful in a wide variety of applications, such as in-line pumps in high flow rate on-board fire-fighting systems, compact high flow rate shipboard emergency water removal systems, in-line high flow fluid transfer pumps in chemical manufacture and distribution, in-line high flow fluid transfer pumps in petroleum refining and distribution, and in line high flow fluid transfer pumps which can maintained in an aseptic environment needed in medical and food applications.

As noted, in one embodiment the present invention provides an electric fluid pump which is an Electric Submersible Pump (ESP) optimized for operation within a well bore and comprising at least one hollow rotor motor provided by the present invention. In one or more embodiments of the present invention, the ESP comprises one or more electric motors configured to one or more pumping sections. In one embodiment, the Electric Submersible Pump (ESP) is optimized for operation within a geothermal well bore having a bore diameter of about 10.625 inches. In one such embodiment, the ESP is configured to utilize approximately 5.0 MW of power, the amount needed to boost 80 kg/second (kg/s) of a 300° C. working fluid (water, with a gas fraction of 2% or less) at a pressure of 300 bar. In such an embodiment, the ESP can be operated to advantage at a pump/motor speed of about 3150 RPM in order to balance system efficiency and pump stage pressure rise with motor thermal concerns. In one or more embodiments, the ESP provided by the present invention comprises approximately 126 impeller/diffuser stages having a total length of about 19 meters and a hollow rotor electric motor sections having a length of about 16 meters, making the combined total length of the ESP motor and pumping sections approximately 35 meters. The total length of an ESP provided by the present invention is typically somewhat longer than the sum of the lengths of the motor and pumping sections due to the presence of additional structural features arrayed along the ESP pump-motor axis, for example a protector section (discussed herein). The total length of an ESP provided by the present invention may vary widely, but in geothermal production well applications, the length of such an ESP will typically fall in a range between 30 and 50 meters. A design-of-experiments analysis using Computational Fluid Dynamics (CFD) carried out by the inventors revealed that pump efficiency as high as 78% could be achieved at a flow rate of 80 kg/second through an ESP according to one or more embodiments of the present invention. In one aspect, the present invention provides an ESP comprising an induction motor. In an alternate embodiment, the present invention provides an ESP comprising a permanent magnet motor. During operation, water impelled by the ESP impeller/diffuser stages passes primarily into and through the bore (also referred to herein at times as the flow channel) of the hollow rotor. In one or more embodiments, the ESP provided by the present invention comprises a modular motor that has been optimized for power density and is divided into 8-10 sections, with a total motor length of approximately 16 meters. High temperature testing of various motor insulation materials, and high-temperature high-pressure evaluations of candidate dielectric coolant fluids have been carried out and suitable candidate motor insulation materials and dielectric coolant fluids have been identified. These include for example, motor insulation materials disclosed in U.S. patent application Ser. Nos. 12/968,437 and 13/093,306 which are incorporated by reference herein in its entirety, and dielectric fluids known in the art, for example perfluorinated polyethers. With a combination of thermal management using circulating dielectric oil, as well as the use of inorganic solid motor insulation materials, a peak motor temperature of <330° C. is attainable and acceptable. In one or more embodiments the ESP provided by the present invention comprises a high pressure, high temperature dielectric fluid flow loop. As will be appreciated by those of ordinary skill in the art the use of a pressurized dielectric fluid within the motor portion of an ESP requires the use of one or more seals to isolate the dielectric fluid from the process fluid.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electric motor comprising:
(a) a motor housing; and
(b) a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel.

2. The electric motor according to claim 1, wherein the smallest cross-sectional area of the flow channel is from 25% to about 75% of the largest cross-sectional area of the motor housing.

3. The electric motor according to claim 1, wherein the smallest cross-sectional area of the flow channel is from about 30% to about 55% of the largest cross-sectional area of the motor housing.

4. The electric motor according to claim 1, further comprising:
a transition section configured to join the hollow rotor to a drive shaft of a device to be powered by the motor; and
one or more intake ports defined by the transition coupling, the first end portion, or both the transition coupling and the first end portion; said intake ports being in fluid communication with the flow channel of the hollow rotor.

5. The electric motor according to claim 4, wherein the intake ports are characterized by one or more cross sectional areas, and wherein a sum of the cross sectional areas of the intake ports is substantially equal to, or larger than, the smallest cross-sectional area of the flow channel.

6. The electric motor according to claim 4, wherein the transition coupling defines one or more intake ports.

7. The electric motor according to claim 4, wherein the first end portion defines one or more intake ports.

8. The electric motor according to claim 4, wherein both the transition coupling and the first end portion define at least one intake port.

9. The electric motor according to claim 4, wherein only the transition coupling defines one or more intake ports.

10. The electric motor according to claim 1, further comprising a pressurized dielectric fluid.

11. The electric motor according to claim 1, wherein a dielectric fluid filled gap separates an outer surface of the hollow rotor from the stator.

12. The electric motor according to claim 1, wherein a gas fluid filled gap separates an outer surface of the hollow rotor from the stator.

13. The electric motor according to claim 1, wherein the stator is encapsulated.

14. An electric fluid pump comprising:
(a) an electric motor comprising:
(i) a motor housing; and
(ii) a hollow rotor configured to rotate within and be driven by a stator contained within the motor housing; wherein the motor housing is characterized by a largest cross-sectional area of the motor housing, and wherein the hollow rotor defines a flow channel characterized by a smallest cross-sectional area of the flow channel, wherein the smallest cross-sectional area of the flow channel is at least 25% of the largest cross-sectional area of the motor housing, and wherein the hollow rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel;
(b) a transition section configured to join the hollow rotor to a drive shaft of a pumping device to be powered by the motor;
(c) one or more intake ports defined by the transition coupling, the first end portion, or both the transition coupling and the first end portion; said intake ports being in fluid communication with the flow channel of the hollow rotor; and
(d) a pumping device comprising a fluid inlet and one or more impellers fixed to a drive shaft powered by the electric motor.

15. The electric fluid pump according to claim 14, comprising a first set of impellers mounted on a first drive shaft, and a second set of impellers mounted on a second driveshaft, said first and second drive shafts being configured to be driven by the hollow rotor, said first and second drive shafts being configured to rotate in opposite directions.

16. The electric fluid pump according to claim 14, further comprising a pumping device housing.

17. The electric fluid pump according to claim 16, further comprising stationary diffusers mounted to an inner surface of the pumping device housing.

18. A machine for electric power generation comprising:
(a) a generator comprising:
(i) a generator housing; and
(ii) a hollow magnetic rotor configured to rotate within a stator contained within the generator housing; wherein the generator housing is characterized by a largest cross-sectional area of the generator housing, and wherein the hollow magnetic rotor defines a flow channel characterized by a smallest cross-sectional area of the flow channel, wherein the smallest cross-sectional area of the flow channel is at least 25% of the largest cross-sectional area of the generator housing, and wherein the hollow magnetic rotor has a first end portion defining a fluid inlet, and a second end portion defining a fluid outlet; the fluid inlet, the flow channel and the fluid outlet being configured to allow passage of a fluid from the fluid inlet to the fluid outlet via the flow channel;
(b) a transition section configured to join the hollow magnetic rotor to a drive shaft of a turbine device configured to drive the hollow magnetic rotor; and
(c) one or more outlet ports defined by the transition coupling, the first end portion, or both the transition coupling and the first end portion; said outlet ports being in fluid communication with the flow channel of the hollow magnetic rotor;
wherein the turbine device comprises one or more impellers fixed to the drive shaft.

19. The machine for electric power generation according to claim 18, further comprising a turbine device housing defining one or more fluid inlet.

20. The machine for electric power generation according to claim 18, wherein the turbine device comprises a turbine device housing defining one or more fluid inlets.

21. The machine for electric power generation according to claim 18, wherein a dielectric fluid filled gap separates an outer surface of the hollow rotor from the stator.

22. The machine for electric power generation according to claim 18, wherein the stator is encapsulated.
